(19) United States
(12) Patent Application Publication
(10) Pub. No.: US 2010/0313241 A1
(43) Pub. Date: Dec. 9, 2010

(54) SYSTEM AND METHOD FOR AUTHENTICATION IN WLAN ENVIRONMENT

(75) Inventors: Sang-Mook Lee, Suwon-si (KR); Seong-Woon Kang, Suwon-si (KR); Jong-Hoon Lim, Suwon-si (KR); Kyu-Hyung Cho, Suwon-si (KR); Joon-Oo Kim, Suwon-si (KR)

Correspondence Address: THE FARRELL LAW FIRM, LLP, 290 Broadhollow Road, Suite 210E, Melville, NY, 11747, US

(73) Assignee: Samsung Electronics Co., Ltd., Suwon-si (KR)

(21) Appl. No.: 12/793,314

(22) Filed: Jun. 3, 2010

(30) Foreign Application Priority Data
Jun. 5, 2009 (KR) 10-2009-00049989

(51) Int. Cl. G06F 15/16

(52) U.S. Cl. 726/3; 709/229

(57) ABSTRACT

An authentication system and method in a wireless LAN (WLAN) environment. A terminal transmits an access authentication request to an access point of a WLAN which the terminal desires to access, and transmits its own transmission power information to the access point when receiving a response to the access authentication request from the access point, and the access point measures received signal strength, calculates a path loss value through the use of the received transmission power and the measured received signal strength, and performs access authentication of the terminal according to the calculated path loss value, so that a new terminal can easily access the WLAN where security has been set up.

### PRIORITY

This application claims priority to an application filed in the Korean Intellectual Property Office on Jun. 5, 2009 and assigned Serial No. 10-2009-0049989, the contents of which are incorporated herein by reference.

### BACKGROUND OF THE INVENTION

1. Field of the Invention

The present invention relates to a system and method for authentication in wireless local area network (WLAN) environments, and more particularly to an authentication system and method for a connection between an access point and a terminal in a WLAN.

2. Description of the Related Art

In general, a wireless local area network (WLAN) is a wireless transmission network based on IEEE 802.11 PHY/MAC, and is widely used in homes and offices.

However, in such a WLAN, since a complex authentication procedure using a network name and a Wired Equivalent Privacy (WEP) key is performed, it is not easy for a beginner or general user to set up WLAN security, and it is not easy for a new terminal to access a WLAN in which security has been set up. For this reason, most WLANs are being used without any security. Accordingly, there is a problem in that a WLAN, in which security has not been set up, can easily be accessed by terminals that are not authorized to use the WLAN.

In order solve such a problem, a Wi-Fi Protected Setup (WPS) standard for easily setting up network security in WLANs of Small Office & Home Office (SOHO) environments has been defined.

The WPS standard, defined as above, includes four authentication methods for performing authentication in a WLAN where security has been set up, wherein the four authentication methods are classified into a necessary implementation scheme and a selective implementation scheme.

First, the necessary implementation scheme includes a Personal Identification Number (PIN) authentication method and a Push Button Configuration (PBC) authentication method.

The PIN authentication method reads a PIN from either a display of a new terminal desiring to enter a WLAN, where security has been set up, or a sticker attached on the new terminal, to input the PIN through an access point or a station (STA) previously connected to the network, and to perform authentication.

The PBC authentication method is implemented by pushing buttons pre-established for authentication on both an access point and a new terminal, and performing authentication.

The selective implementation scheme includes a Near-Field Communication (NFC) authentication method and a Universal Serial Bus (USB) authentication method.

The NFC authentication method is implemented by bringing a new terminal, which includes additional hardware such as an RFID tag, close to an access point, and to perform authentication between the new terminal and the access point in a network where security has been set up.

The USB authentication method stores information required for authentication on a USB stick by inserting the USB stick into an access point, to insert the USB stick into a new terminal, and to perform authentication.

As described above, according to the conventional methods, in order to access a WLAN where security has been set up, authentication is performed in such a manner as to use a previously connected terminal or to push an authentication request button. In addition, according to the conventional methods, authentication between an access point and a terminal is performed using an RFID or hardware, such as an USB stick.

However, according to conventional methods, in order to perform authentication between an access point and a terminal on a WLAN, either additional hardware must be provided, or a number such as a PIN for authentication must be pre-established, which is inconvenient for the user.

### SUMMARY OF THE INVENTION

Accordingly, the present invention has been made to solve the above-mentioned problems occurring in the prior art, and the present invention provides a system and method for easily performing authentication between an access point and a new terminal through the use of a pre-defined function in a wireless local area network (WLAN) where security has been setup.

In accordance with an aspect of the present invention, there is provided an authentication system using a path loss in a wireless LAN (WLAN) environment, the system including a terminal for searching for one or more access points, selecting an access point of a WLAN, which the terminal desires to access, from among the searched access points, transmitting an access authentication request to the access point which has been selected, and transmitting transmission power information of the terminal to the access point when receiving a response to the access authentication request from the access point; and the access point for transmitting the response to the access authentication request to the terminal when receiving the access authentication request, measuring a received signal strength of the access point when receiving the transmission power information from the terminal, calculating a path loss value through the use of the received transmission power and the measured received signal strength, and performing an access authentication of the terminal according to the calculated path loss value.

In accordance with another aspect of the present invention, there is provided an authentication method using a path loss in a wireless LAN (WLAN) environment, the method including searching, by a terminal, for one or more access points; selecting, by the terminal, an access point of a WLAN, which the terminal desires to access, from among the searched access points; transmitting, by the terminal, an access authentication request for an access to the selected access point, to the selected access point; transmitting, by the access point, a response to the access authentication request to the terminal; transmitting, by the terminal, transmission power information of the terminal to the access point; measuring, by the access point, received signal strength of the access point when the access point has received the transmission power information of the terminal; calculating, by the access point, a path loss value through the use of the received transmission power and the measured received signal strength; and performing, by the access point, an access authentication of the terminal according to the calculated path loss value.

### BRIEF DESCRIPTION OF THE DRAWINGS

The above and other aspects, features and advantages of the present invention will be more apparent from the following detailed description taken in conjunction with the accompanying drawings, in which:

FIG. 1 is a view illustrating the configuration of an authentication system according to an embodiment of the present invention;

FIG. 2 is a block diagram illustrating the configuration of a terminal and an access point according to an embodiment of the present invention;

FIGS. 3A and 3B are views illustrating the formats of the conventional TPC request frame and TPC report frame;

FIG. 4 is a view illustrating the format of an authentication request frame according to an embodiment of the present invention;

FIG. 5 is a flowchart illustrating a process of performing an access authentication between an access point and a terminal according to an embodiment of the present invention; and

FIG. 6 is a graph illustrating a path loss value in a 2.4 GHz band according to distances between an access point and a terminal in free space.

### DETAILED DESCRIPTION OF EMBODIMENTS OF THE INVENTION

Hereinafter, various embodiments of the present invention will be described with reference to the accompanying drawings. In the following description, a detailed description of known functions and configurations incorporated herein will be omitted when it may make the subject matter of the present invention less unclear.

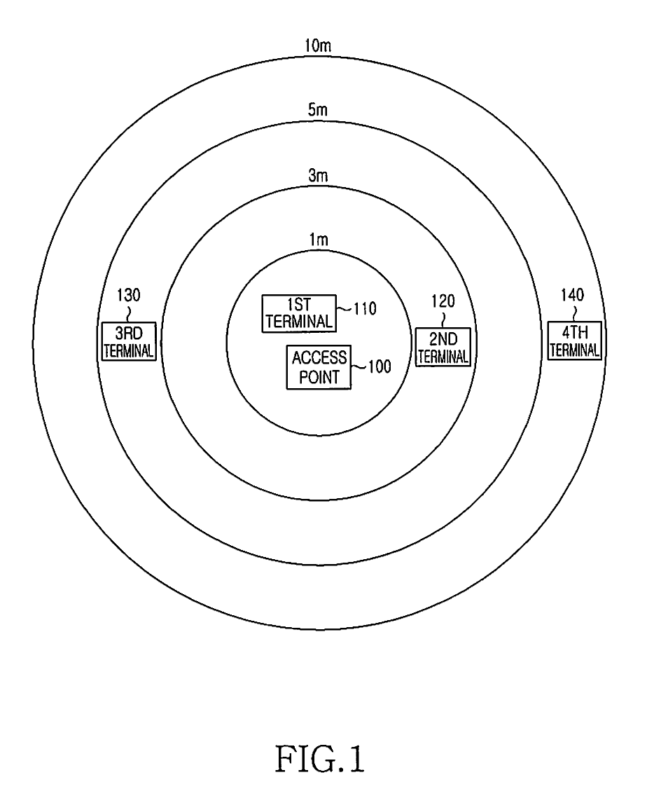

FIG. 1 is a view illustrating the configuration of a network authentication system according to an embodiment of the present invention.

According to an embodiment of the present invention, the network authentication system includes an access point 100 and at least one terminal, for example, first terminal 110. First, the access point 100 periodically transmits a beacon frame, which includes a Service Set Identifier (SSID) and a MAC address, to at least one terminal, such as a first terminal 110, a second terminal 120, a third terminal 130, and/or a fourth terminal 140.

When periodically receiving beacon frames from adjacent access points, the first terminal 110 selects an access point, e.g. the access point 100, in a WLAN, which the first terminal 110 desires to access.

Then, the first terminal 110 transmits a network connection request frame for a network connection to the selected access point 100.

After receiving the network connection request frame for network connection from the first terminal 110, the access point 100 transmits a network connection response frame to the first terminal 110 in response to the network connection request.

After receiving the network connection response frame from the access point 100, the first terminal 110 creates a transmission power frame, including its own transmission power information, according to the network connection response frame, and transmits the created transmission power frame to the access point 100.

After receiving the transmission power information of the first terminal 110, the access point 100 measures its own received signal strength, and calculates a path loss value through the use of the received transmission power information and the measured received signal strength information.

The access point 100 accepts or rejects the authentication of the first terminal 110 according to the calculated path loss value.

Accordingly, in the present invention, the authentication between a terminal and an access point can be easily performed through the use of a path loss between the terminal and the access point.

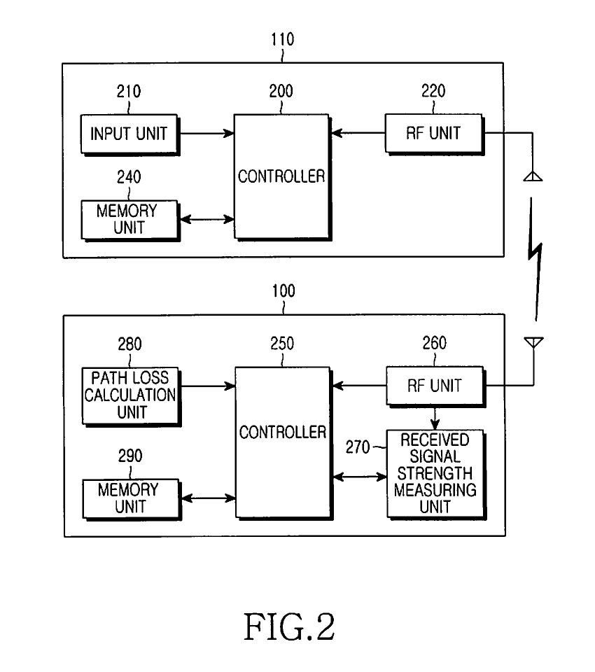

FIG. 2 is a block diagram illustrating the configuration of the first terminal 110 and the access point 100 according to an embodiment of the present invention.

The first terminal 110 includes a controller 200, an input unit 210, an RF unit 220, and a memory unit 240.

The controller 200 controls the general operation of the first terminal 110, and particularly, searches for adjacent access points when a network access request is issued through the input unit 210. In this case, the access points will periodically transmit beacon frames.

When an input selecting one access point from among the searched access points is received through the input unit 210, the controller 200 transmits a network connection request frame to the selected access point. An embodiment of the present invention will be described assuming that the selected access point is the access point 100.

Here, the network connection request frame is created through the use of a Transmit Power Control (TPC) function of controlling transmission power and protecting the system, among functions of the WLAN that are used to reduce the interference with a radar or satellite communication.

Specifically, the TPC function can be used in both the 5 GHz and the 2.4 GHz bands, provides an association between an access point and a terminal, can satisfy transmission power stipulations having limitations depending factors which may affect path loss and can change transmission power.

Such a TPC function is performed through the exchange of a TPC request frame and a TPC report frame.

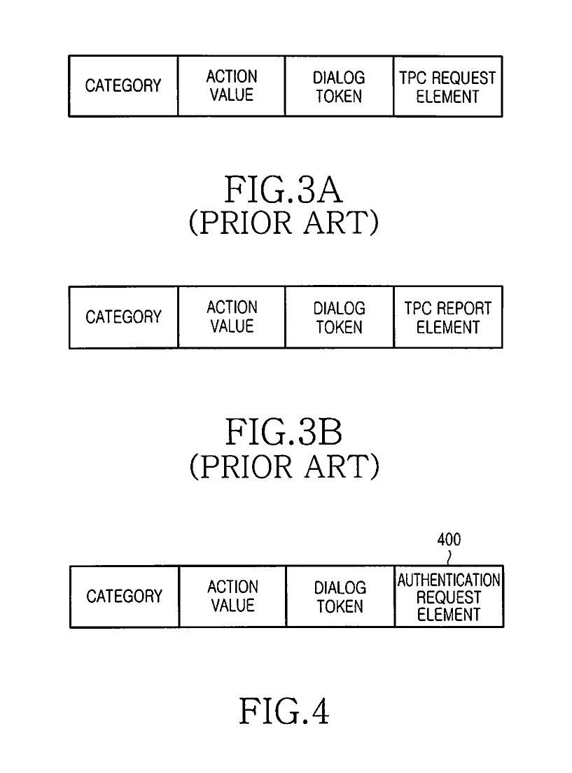

Here, the TPC request frame is used to request transmission power, and has a frame format, such as that shown in FIG. 3A. Also, the TPC report frame includes a report of a transmission power request and transmission power information, and has a frame format, such as that shown in FIG. 3B. In this case, transmission power information of the first terminal 110 is included in the TPC report element, shown in FIG. 3B.

Accordingly, a transmission power frame according to an embodiment of the present invention may be configured within a reserved area of an action frame defined in IEEE 802.11, based on the aforementioned TPC request and report frames, as shown in FIG. 4. Among the components of the transmission power frame, an authentication request element 400 may include information such as a TPC request element.

Thereafter, when receiving a network connection response frame through the RF unit 220 from the access point 100, the controller 200 decides its own transmission power, and transmits a frame including the decided transmission power through the RF unit 220 to the access point 100. Here, the transmission power means power used when the first terminal 110 transmits frame data to the access point 100.

The input unit 210 includes keys for accessing a WLAN and a key for selecting an access point of a network that the terminal desires to access.

The RF unit 220 receives the beacon frame and the network connection response frame from the access point 100, and transmits the network connection request frame to the access point 100.

The memory unit 240 stores the beacon frame and the network connection response frame, which are received through the RF unit 220.

Meanwhile, the access point 100 includes a controller 250, an RF unit 260, a received signal strength measuring unit 270, a path loss calculation unit 280, and a memory unit 290.

The controller 250 controls the general operation of the access point 100, and particularly, periodically transmits a beacon frame to adjacent terminals through the RF unit 260.

After receiving the network connection request frame through the RF unit 260 from the first terminal 110, the controller 250 creates and transmits a network connection response frame through the RF unit 260 to the first terminal 110.

Thereafter, after receiving a transmission power frame including transmission power information from the first terminal 110, the controller 250 stores the received transmission power information in the memory unit 290, and measures its own received signal strength, i.e., a Received Signal Strength Indicator (RSSI), through the received signal strength measuring unit 270.

After measuring the received signal strength, the controller 250 calculates a path loss value through the path loss calculation unit 280 by means of the received transmission power of the first terminal 110 and its own received signal strength that has been measured.

Thereafter, the controller 250 determines whether to accept authentication for network connection of the first terminal 110 based on the calculated path loss value.

Specifically, the controller 250 predetermines a threshold value for determining whether to accept authentication, and compares the calculated path loss value with the predetermined threshold value. The threshold value may vary.

When the path loss value is less than or equal to the predetermined threshold value as a result of the comparison, the controller 250 accepts the authentication of the first terminal 110, and completes the network connection with the first terminal 110. In contrast, when the path loss value is greater than the predetermined threshold value, the controller 250 rejects the authentication of the first terminal 110, and does not make the network connection with the first terminal 110. Here, the threshold value may vary depending on an authentication acceptance range that is determined by a network administrator.

The RF unit 260 transmits the beacon frame and the network connection response frame to the terminal, and receives the transmission power frame from the terminal.

The received signal strength measuring unit 270 measures the received signal strength of the access point 100, wherein the received signal strength means the signal strength which the access point 100 measures while receiving transmission power frame data from the first terminal 110.

The path loss calculation unit 280 calculates a path loss value through the use of the transmission power of the first terminal 110, which has been received, and the received signal strength of the access point 100, which has been measured. A path loss value in free space can be measured by Equation (1) below.

$$Path Loss [ d B ] = 20 {log}_{10} ( \frac{4 π d}{λ} ) \qquad ( 1 )$$

In Equation (1), “d” represents a distance between the first terminal 110 and the access point 100, and “λ” represents a wavelength, which can be calculated from the operating frequency.

The memory unit 290 stores the network connection request frame received from the first terminal 110, or stores the transmission power of the first terminal 110, which is received.

When the network connection between the access point 100 and the first terminal 110 has been completed, as described above, the access point 100 and the first terminal 110 perform general data transmission/reception operations.

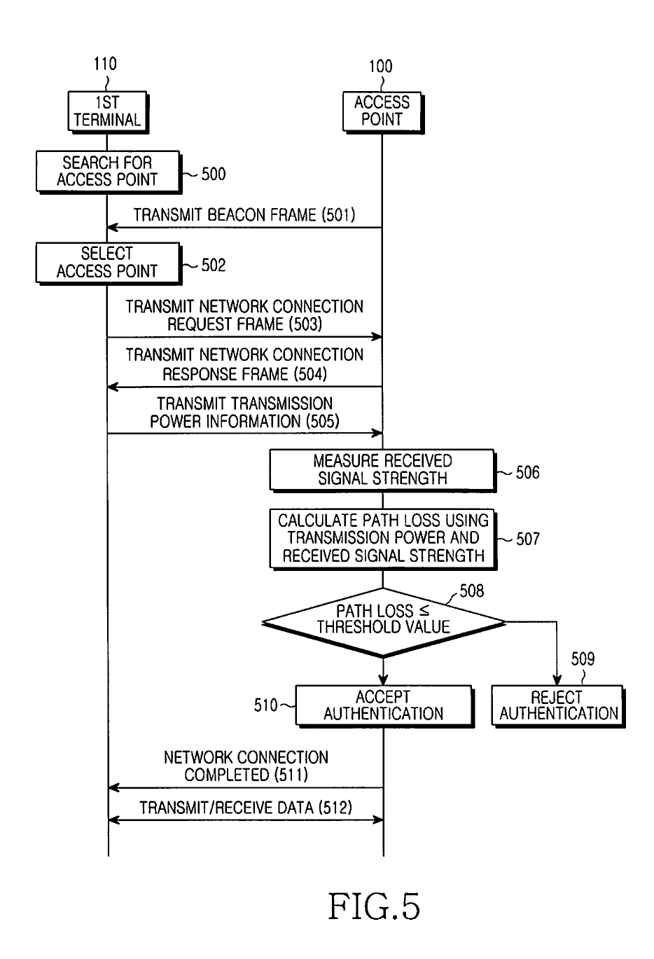

FIG. 5 is a flowchart illustrating an authentication process for a network connection between an access point and a terminal according to an embodiment of the present invention.

In order to access a WLAN, the first terminal 110 searches for adjacent access points in step 500.

The access point 100 transmits a beacon frame, including an SSID and a MAC address, to the first terminal 110 in step 501.

When the first terminal 110 receives beacon frames from the searched access points, the first terminal 110 selects an access point, e.g. the access point 100, of the WLAN, which the first terminal 110 desires to access, in step 502.

After selecting the access point 100, the first terminal 110 creates and transmits a network connection request frame to the selected access point 100 in step 503.

When the access point 100 receives the network connection request frame from the first terminal 110, the access point 100 creates and transmits a network connection response message to the first terminal 110 in step 504.

When the first terminal 110 receives the network connection response message from the access point 100, the first terminal 110 creates and transmits a transmission power frame, including its own transmission power information, to the access point 100 in response to the response message in step 505.

When the access point 100 receives the transmission power frame from the first terminal 110, the access point 100 measures its own received signal strength in step 506, and calculates a path loss value through the use of the calculated received signal strength and the received transmission power in step 507. In this case, the path loss value is calculated by subtracting the received signal strength from the transmission power. In addition, such a path loss value may be utilized as information for deciding a threshold value in the access point.

After calculating the path loss value, the access point 100 compares the calculated path loss value with a predetermined threshold value and determines if the calculated path loss value is less than or equal to the predetermined threshold value in step 508.

When the calculated path loss value is less than or equal to the predetermined threshold value as a result of the determination, the access point 100 accepts the authentication for network connection of the first terminal 110 in step 510, and completes the network connection with the first terminal 110 in step 511.

In contrast, when the calculated path loss value is greater than the predetermined threshold value as a result of the determination, the access point 100 rejects the authentication for network connection of the first terminal 110 in step 509, and does not make the network connection.

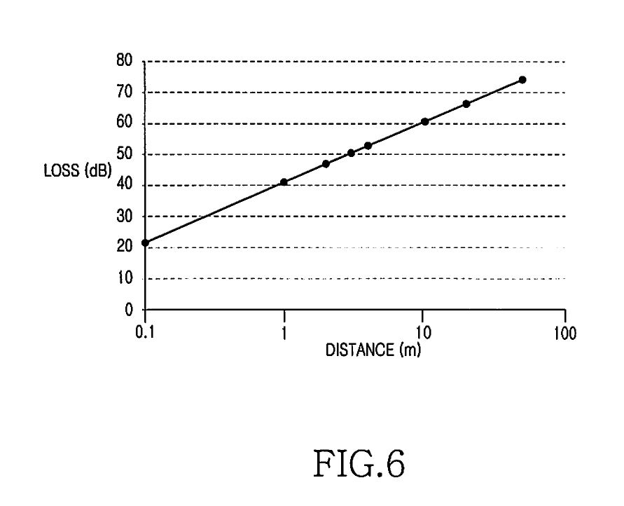

For example, it is assumed that the access point 100 accepts network connection with terminals, which are located within a range of a 1-meter radius from the access point 100. A path loss value in a 2.4 GHz band according to distances between an access point and a terminal may be expressed as a graph shown in FIG. 6.

Referring to FIG. 6, a path loss value is calculated to be 40 dB when an access point and a terminal are at a distance of 1 meter from one another. When the calculated path loss value is 40 dB, as described above, the access point 100 may set a threshold value for authentication acceptance to 45 dB by adding the maximum error allowance of 5 dB to the path loss value of 40 dB. Here, the set threshold value may vary.

If the path loss value of the second terminal 120 is less than or equal to 45 dB which is a threshold value set in the access point 100, the access point 100 recognizes the second terminal 120 as a terminal located within a range of a 1 meter radius from the access point 100, and transmits an authentication key to the second terminal 120 or completes network connection with the second terminal 120. That is, when a terminal requesting authentication is located within a range of a 1-meter radius from the access point 100, the access point 100 accepts the authentication for network connection of the terminal.

The above description is given for an authentication procedure for network connection in a Basic Service Set (BSS), which is constituted with an access point and terminals.

According to another embodiment of the present invention, an authentication procedure for network connection may be performed even in an Independent Basic Service Set (IBSS), which is constituted with terminals. In order to perform an authentication procedure in the IBSS, one of the terminals is set as a virtual access point, so that it is possible to perform authentication for network connection between the set terminal and other terminals.

As described above, according to the embodiments of the present invention, a path loss value is calculated through the use of the transmission power of a terminal and the received signal strength of an access point, and authentication for network connection of the terminal is performed through the use of the calculated path loss value, so that even beginners or general users can easily access WLANs that have security enabled.

According to the present invention, a path loss value is calculated through the use of the transmission power of a terminal and the received signal strength of an access point, and an authentication procedure is performed according to the calculated path loss value, so that new terminals can easily access a WLAN where security has been set up.

In addition, according to the present invention, even a beginner or general user can bring a terminal, desired to be authenticated, close to an access point in a WLAN where security has been set up, and can easily make an authentication request.

While the present invention has been shown and described with reference to certain embodiments thereof, it will be understood by those skilled in the art that various changes in form and details may be made therein without departing from the spirit and scope of the invention as defined by the appended claims. Accordingly, the scope of the invention is not to be limited by the above embodiments but by the claims and the equivalents thereof.

What is claimed is:

1. An authentication system using a path loss in a wireless LAN (WLAN) environment, the system comprising:
a terminal for searching for one or more access points, selecting an access point of a WLAN which the terminal desires to access, from among the searched access points, transmitting an access authentication request to the access point which has been selected, and transmitting transmission power information of the terminal to the access point after receiving a response to the access authentication request from the access point; and
the access point for transmitting the response to the access authentication request to the terminal after receiving the access authentication request, measuring a received signal strength of the access point when receiving the transmission power information from the terminal, calculating a path loss value through the use of the received transmission power and the measured received signal strength, and performing an access authentication of the terminal according to the calculated path loss value.

2. The system as claimed in claim 1, wherein the access point compares the calculated path loss value with a threshold value which has been preset for an access authentication of the terminal, accepts the access authentication of the terminal when the calculated path loss value is less than or equal to the threshold value as a result of the comparison, and performs the access authentication of the terminal.

3. The system as claimed in claim 2, wherein, when the calculated path loss value is greater than the threshold value as a result of the comparison, the access point rejects the access authentication of the terminal, and cancels the access authentication of the terminal.

4. The system as claimed in claim 2, wherein the threshold value is variably set depending on a range in which authentication is allowed.

5. An authentication method using a path loss in a wireless LAN (WLAN) environment, the method comprising the steps of:
searching, by a terminal, for one or more access points;
selecting, by the terminal, an access point of a WLAN, which the terminal desires to access, from among the searched access points;
transmitting, by the terminal, an access authentication request for access to the selected access point, to the selected access point;
transmitting, by the access point, a response to the access authentication request to the terminal;
transmitting, by the terminal, transmission power information of the terminal to the access point;
measuring, by the access point, received signal strength of the access point after the access point has received the transmission power information of the terminal;
calculating, by the access point, a path loss value through the use of the received transmission power and the measured received signal strength; and
performing, by the access point, an access authentication of the terminal according to the calculated path loss value.

6. The method as claimed in claim 5, wherein performing, by the access point, the authentication comprises:
comparing the calculated path loss value with a threshold value which has been preset for an access authentication of the terminal; and
accepting the access authentication of the terminal when the calculated path loss value is less than or equal to the threshold value as a result of the comparison.

7. The method as claimed in claim 6, wherein performing, by the access point, the authentication comprises rejecting the access authentication of the terminal when the calculated path loss value is greater than the threshold value as a result of the comparison.

8. The method as claimed in claim 6, wherein the threshold value is variably set depending on a range in which authentication is allowed.
